(19) United States
(12) Patent Application Publication
(10) Pub. No.: US 2020/0070621 A1
(43) Pub. Date: Mar. 5, 2020

(54) METHOD AND SYSTEM FOR CONDITIONING THE AIR IN A PASSENGER COMPARTMENT OF AN ELECTRIC VEHICLE, AND ELECTRIC VEHICLE IMPLEMENTING SUCH A METHOD OR SYSTEM

(71) Applicant: BLUEBUS, Ergue Gaberic (FR)

(72) Inventors: Alexandre DESNEUX, Saint Laurent De Mure (FR); Christophe BARDOT, Montigny-le-Bretonneux (FR); Fabien DURAND, Decines (FR); Alexandre MATHIEUX, Lyon (FR); Freddy SUAUD, Mions (FR)

(21) Appl. No.: 16/613,776

(22) PCT Filed: May 17, 2018
(86) PCT No.: PCT/EP2018/062888

§ 371 Date: Nov. 14, 2019

(30) Foreign Application Priority Data
May 18, 2017 (FR) 1754396

(51) Int. Cl. B60H 1/00; B60W 10/30; B60L 50/60

(52) U.S. Cl. CPC B60H 1/00428; B60H 1/004; B60H 1/00821; B60L 2200/18; B60L 50/66; B60W 2300/10; B60W 10/30

(57) ABSTRACT

A method for conditioning the air of the passenger compartment of an electric vehicle, which includes:
a preliminary step conditioning the air in at least one portion of the passenger compartment by an air-conditioning device supplied with power by a power source external to the vehicle, when the vehicle is linked to the external power source; and
a main step conditioning the air in the at least one portion of the passenger compartment, by an air-conditioning device supplied with power by a vehicle fossil power source during use of the vehicle; the preliminary step conditioning the air giving priority to the conditioning of the air, in a driver area of the vehicle. A system implementing such a method and an electric vehicle, in particular, an electric bus, implementing such a method or system is also provided.

The present invention relates to a method for conditioning the air in a passenger compartment of an electric vehicle, in particular an electric vehicle in which all of the energy for the movement thereof is supplied by an on-board electrical energy source which can be recharged from an external source. It also relates to a system implementing such a method and to an electric vehicle, in particular of the bus type, implementing such a method or such a system.

The field of the invention is the field of systems for conditioning the air of a passenger compartment of an electric vehicle, and in particular for an electric vehicle in which all of the energy for the movement thereof is supplied by an on-board electrical energy source which can be recharged from an external source.

### PRIOR ART

The bus is one of the most valued means of public transport because its utilization does not require specific infrastructure, for example of the track type. Electric buses are emerging in order to reduce pollution associated with public transport, encouraged both by user awareness and also by administrative incentives promoting the purchase and use of electric vehicles. We are also witnessing the emergence and development of tyred trams. Thus, the number of buses, electric or otherwise, is continuously increasing.

For electric buses supplied by rechargeable batteries from an external source, in contrast to hybrid buses, the operating range is a key issue. In order to increase the operating range of these buses, a combustion heater is used in order to heat the passenger compartment. Thus, the energy required to heat the passenger compartment is not taken from the batteries.

Now, the combustion heater cannot be used all of the time, for example, when the vehicle is in the garage. In addition, a combustion heater increases the pollution generated by the electric vehicle and the fuel consumption of said vehicle.

An aim of the present invention is to overcome these drawbacks.

Another aim of the invention is to propose a method and a system for conditioning the air in the passenger compartment of an electric vehicle being able to be used even when the vehicle is stationary.

An aim of the invention is also to propose a method and a system for conditioning the air in the passenger compartment of an electric vehicle generating less pollution.

Yet another aim of the invention is to propose a method and a system for conditioning the air in the passenger compartment reducing the fuel consumption of said electric vehicle.

### SUMMARY OF THE INVENTION

The invention makes it possible to achieve at least one of these aims by means of a method for conditioning the air in the passenger compartment of an electric vehicle, characterized in that it comprises:
a step, called preliminary step, carrying out a conditioning of the air in at least one part of said passenger compartment by at least one air conditioning device supplied by an electrical source external to the vehicle, when said vehicle is connected to said external electrical source, such as for example the power grid, and
a step, called main step, carrying out a conditioning of the air in said at least one part of said passenger compartment by at least one air conditioning device supplied by a fossil fuel-based electricity source on board said vehicle, during use of said vehicle.

Thus, the method according to the invention proposes to carry out a preliminary air conditioning phase in the vehicle from an electrical source external to the vehicle, when the vehicle is connected to said external electrical source, such as the power grid for example. In this case, the air conditioning device(s) are supplied by the external electrical source, directly or via the batteries of the vehicle. Such a situation can occur when the vehicle is stationary, in order to recharge its batteries, or when the vehicle is in a garaged phase waiting to be used. Then, when the vehicle is disconnected in order to be used, on the road for example, the air conditioning in the vehicle is carried out by a fossil fuel source on board the vehicle, and in particular dedicated to the conditioning of air, so that the air conditioning does not consume electrical energy stored in the batteries of the electric vehicle.

As a result, using the method according to the invention, the air located in the passenger compartment of an electric vehicle can be conditioned even when the vehicle is stopped, while reducing the pollution generated by the electric vehicle and the fuel consumption of said electric vehicle.

In the present application, by “air conditioning” is meant any treatment of the air, except for heating. In particular, the air conditioning can be cooling, and/or refreshing, and/or dehumidifying, and/or deodorizing, etc.

In the present application, “tyred tram” denotes an electric public transport land vehicle mounted on wheels and which is recharged at each station, so that it has no need for heavy infrastructures of the rails or catenaries type on the road system. Such an electric vehicle recharges at each station by means of charging elements of the station and a connector connecting said vehicle to said station.

According to the invention, the main step and/or the preliminary step can relate only, or firstly to one part of the passenger compartment of the vehicle.

According to a preferred embodiment, the preliminary step can carry out air conditioning only, or firstly or even as a priority in a driver's area of the vehicle, also called a driver's position.

According to an embodiment, the preliminary step can carry out air conditioning only in a driver's area of said vehicle.

According to another embodiment, the preliminary step can carry out air conditioning firstly in a driver's area of said vehicle, then in a passenger area, at the same time as or after the air conditioning in the driver's area.

According to yet another embodiment, the preliminary step can carry out air conditioning as a priority in a driver's area of said vehicle. In this embodiment, during the preliminary step, the driver and passenger areas can be conditioned at the same time with a priority to the driver's area.

For example, weighting coefficients can be attributed to each of the driver and passenger areas, so that the driver's area receives a higher conditioning capacity than that of the passenger area.

Preferentially, the weighting coefficient of each area can be used to regulate the conditioning capacity supplied by the air conditioning device.

According to a non-limitative embodiment example, during the preliminary step, the driver's area can receive 80% of the conditioning capacity supplied by the air conditioning device and the passenger area the remaining 20%.

Alternatively, the main step and/or the preliminary step can relate to the entire passenger compartment of the vehicle.

The method according to the invention can advantageously comprise a step of initiating the preliminary step, in particular at a distance from the vehicle.

Such a preliminary air conditioning step can be initiated by a timer integrated into the vehicle.

Alternatively, such a preliminary air conditioning step can be initiated by a remote device, for example a remote server or a portable user device, through a wireless or wired communication network. Such a preliminary air conditioning step can also be initiated by an electrical charging terminal to which the vehicle is connected.

The connection between the server and/or the charging terminal can be carried out in a wired manner, for example using the pilot wire of a charging cable connecting said vehicle to said charging terminal. Alternatively, the connection between the server and/or the charging terminal and/or the user device can be carried out wirelessly, for example through a wireless communication network, such as the network used for mobile telephony.

The preliminary air conditioning step can, alternatively or in addition, be initiated automatically depending on at least one of the following parameters:
a predetermined time,
a predetermined period before said vehicle is collected, for example following an inactive/garaged phase of the vehicle,
an external temperature,
an internal temperature in at least one part of the passenger compartment,
an external humidity level, and
an internal humidity level in at least one part of the passenger compartment.

According to a non-limitative embodiment example, the preliminary air conditioning step can be initiated when the driver comes to collect the vehicle, for example in the morning, for example 30 minutes before the time at which the vehicle is collected.

In certain cases, the main air conditioning step can be carried out from at least one battery of the vehicle, in addition to the fossil fuel-based electricity source on board said vehicle.

In this case, the batteries of the vehicle continuously or temporarily provide energy in addition to that supplied by the fossil fuel source, for example when the fossil fuel source is insufficient, depending on the temperature, and/or the humidity level required in the passenger compartment.

Advantageously, the preliminary air conditioning step can be carried out without starting the electric motor(s) of the electric vehicle.

In other words, the preliminary air conditioning step can be entirely independent of the use of the electric motor(s) for driving the electric vehicle.

The main step can be initiated automatically when:
the preliminary step is stopped,
the vehicle begins to move,
the vehicle is disconnected from the external electrical source, and/or
the temperature, respectively the humidity level, inside the at least one part of the passenger compartment which was conditioned during the preliminary step reaches a predetermined value;
   immediately or optionally after a predetermined period following at least one of these events.

Initiation of the main air conditioning step can in addition be conditional on manual confirmation by an operator or a driver of said vehicle.

Alternatively, the main air conditioning step can be initiated manually, for example by a driver of said vehicle.

The preliminary step can be stopped automatically when:
the main step is initiated,
the vehicle begins to move,
the vehicle is disconnected from an external electrical source, and/or
the temperature, respectively the humidity level, inside the at least one part of the passenger compartment which was conditioned during the preliminary step reaches a predetermined value;
   immediately or optionally after a predetermined period following at least one of these events.

Stopping the preliminary step can in addition be conditional on manual confirmation by an operator or a driver of said vehicle.

Alternatively, the preliminary step can be stopped manually, for example by a driver of said vehicle.

Advantageously, the preliminary step and the main step can be carried out by heat energy transfer to a heat-transfer fluid, in particular in the case of cooling, or refreshing the air.

In this case, the heat-transfer fluid for the main step and the preliminary step can be one and the same heat-transfer fluid.

The heat-transfer fluid can be water or a refrigerant gas.

The fossil fuel-based electricity source on board the vehicle can be dedicated to the air conditioning device(s).

The fossil fuel-based electricity source can be an electrical generator supplied by a fuel of the petrol or gasoil type, or by biofuel.

According to another aspect of the invention, a system for conditioning the air in the passenger compartment of an electric vehicle is proposed, comprising:
at least one electrical air conditioning unit,
at least of fossil fuel-based electrical energy source, such as an electrical generator supplied by a fossil fuel tank;
   configured in order to implement all the steps of the method according to the invention.

In the event that the air conditioning is a cooling of air, the air conditioning unit can be an air conditioning unit comprising, in particular, a compressor and a condenser.

In this case, the air conditioning can be carried out via a heat-transfer fluid, such as a refrigerant, well known to a person skilled in the art.

In this embodiment, the system according to the invention can comprise:
a circuit for circulating said fluid in the passenger compartment of the vehicle, and
at least one evaporator, also called terminal in the rest of the application, connected to said circuit.

According to another aspect of the same invention, an electric vehicle is proposed comprising:
an air conditioning system according to the invention; or
means for implementing all the steps of the method according to the invention.

The electric vehicle according to the invention can in particular be an electric public transport land vehicle, in particular on-rail or on-roads, for example of the bus, coach or tyred tram type.

The vehicle according to the invention can comprise one or more electrical energy storage modules that can be recharged from an external source, such as the power grid.

Each rechargeable electrical energy storage module can comprise one or more rechargeable battery(ies), or supercapacitor(s).

To this end, the vehicle is equipped with at least one electrical recharging socket and/or cable. Such a cable and/or such a socket can comprise a pilot wire allowing:
communication with the vehicle, and/or
detection of the connection and/or the disconnection of said vehicle to an external electrical source.

### DESCRIPTION OF THE FIGURES AND EMBODIMENTS

Other advantages and characteristics will become apparent from examining the detailed description of embodiments which are in no way limitative, and the attached drawings, in which:

FIG. 1 is a diagrammatic representation of a non-limitative example of an electric vehicle according to the invention;

FIG. 2 is a diagrammatic representation of a non-limitative example of a method according to the invention;

FIG. 3 is a diagrammatic representation of a non-limitative example of an air conditioning system according to the invention; and

FIG. 4 is a partial diagrammatic representation of the vehicle in FIG. 1 with the system in FIG. 3.

It is well understood that the embodiments that will be described hereinafter are in no way limitative. In particular, variants of the invention can be envisaged that comprise only a selection of the characteristics described below in isolation from the other features described, if this selection of features is sufficient to provide a technical advantage or to differentiate the invention with respect to the state of the prior art. This selection comprises at least one, preferably functional, characteristic without structural details, or with only a part of the structural details if this part alone is sufficient to confer a technical advantage or to differentiate the invention with respect to the state of the prior art.

In the figures, elements common to several figures retain the same reference.

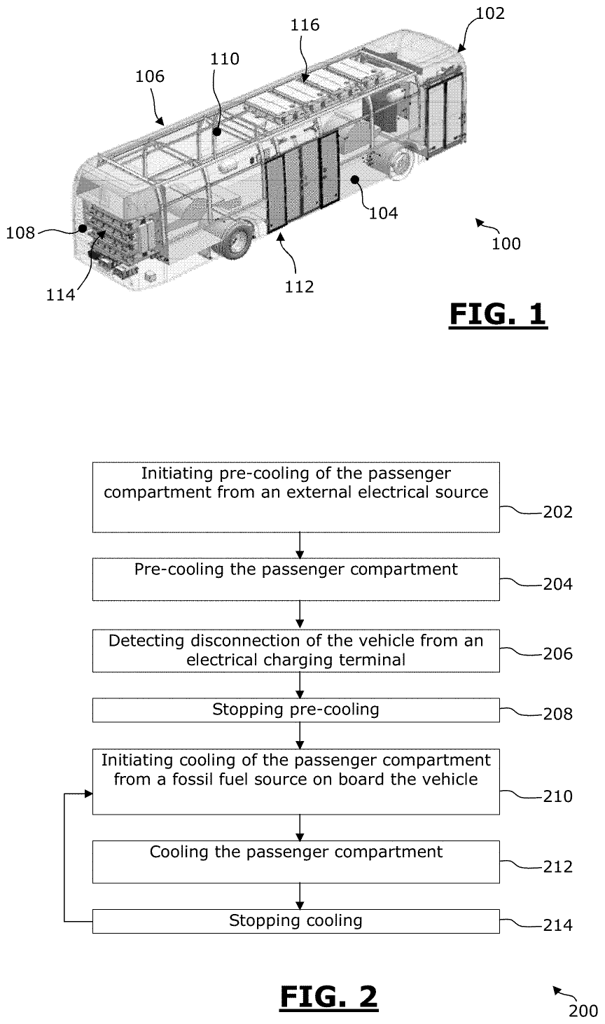

FIG. 1 is a diagrammatic representation of a non-limitative example of an electric vehicle according to the invention.

The electric vehicle 100 shown in FIG. 1 is an electric bus comprising a passenger compartment delimited by a front wall 102, two longitudinal side walls 104 and 106, a rear wall 108, an upper wall 110 and a lower wall 112.

The electric bus comprises one or more electrical motors (not shown), electrical energy storage modules 114, called rear electrical energy storage modules, placed on the side of the rear wall 108. The bus 100 comprises in addition electrical energy storage modules 116, called upper electrical energy storage modules, placed in a housing arranged in the upper wall 110 of the bus 100.

The electric bus 100 is driven exclusively by the electrical energy supplied by the electrical energy storage modules 114 and 116, which can be batteries or supercapacitors.

The electrical energy storage modules 114 and 116 are recharged from an external electrical source, for example via a recharging cable or a pantograph, optionally comprising a pilot wire.

FIG. 2 is a diagrammatic representation of a non-limitative example of a method according to the invention, in the particular case of a cooling of air.

The method 200, shown in FIG. 2 comprises a step 202 of initiating a preliminary step of cooling, also called pre-cooling, of the passenger compartment, or of at least one part of the passenger compartment such as the driver's position, for example of the bus 100 in FIG. 1. The pre-cooling step is carried out by an air conditioning unit, supplied by an electricity source external to the vehicle to which said vehicle is connected, such as for example the power grid, directly or via one or more batteries.

The initiation step 202 comprises starting of the air conditioning unit.

The initiation step is carried out automatically, for example by a timer integrated in the vehicle and controlling the supply of the air conditioning unit.

Alternatively, the initiation of the pre-cooling step can be carried out by a remote server or by a charging terminal. The connection between the server and/or the charging terminal can be carried out in a wired manner, for example using the pilot wire of a charging cable connecting said vehicle to said charging terminal.

Alternatively, the connection between the server and/or the charging terminal can be carried out wirelessly, for example through a wireless communication network, such as the communication network used for mobile telephony.

According to an example embodiment, the pre-cooling step is initiated 15 minutes before the time the vehicle is collected for use, after an inactive step of the vehicle.

Initiation of the pre-cooling of the vehicle can be conditional on detecting the connection of said vehicle to an external electrical source. Such a detecting of the connection can be carried out via a pilot wire of the charging cable, or of the charging terminal of the electric vehicle.

A step 204 carries out pre-cooling of at least one part, or the entirety, of the passenger compartment of the vehicle by the air conditioning unit, through one or more terminals, or evaporators, distributed in the vehicle. The pre-cooling step is carried out until a predetermined temperature is reached, for example 25° C., and while the electric vehicle remains connected to the external electrical source. In fact, the air conditioning unit is supplied by the external electrical source.

Pre-cooling is carried out via a refrigerant, such as a refrigerant gas. The frigories stored by the fluid are then introduced into at least one part of the passenger compartment, such as the driver's position, using one or more evaporators.

A step 206 detecting the disconnection of the vehicle from the external electrical source. Such a detection can be carried out automatically using a pilot wire of the charging cable, or the charging terminal of the electric vehicle.

After detecting the disconnection, a step 208 carries out stopping the pre-cooling carried out using the energy supplied by the external source.

After stopping the pre-cooling, a step 210 carries out initiation of a main step of cooling, also called cooling, either of the part of the passenger compartment which was pre-cooled during the step 204, or of the entirety of the passenger compartment, with a fossil fuel source as an energy source on board the vehicle, such as for example a generator set operating on biofuel. This cooling step is carried out while the temperature of the passenger compartment is greater than a desired temperature, for example 21° C. The step 210 of initiating the cooling step can be conditional on the carrying out of at least one additional condition such as movement of the vehicle, or a manual confirmation by the driver, or the absence of a connection of the vehicle to an external electrical source, etc.

A step 212 thus carries out cooling either of the part of the passenger compartment which was pre-cooled during the step 204, or of the entirety of the passenger compartment, with the energy supplied by the generator set, in order to reach a pre-set desired temperature and as long as the additional condition(s) given above are respected.

Cooling is carried out via the same air conditioning unit and the same refrigerant as those used for the pre-cooling,

When the desired temperature is reached, or when one of the additional conditions is not respected, or even at the request of the driver, a step 214 stops the cooling step.

The steps 210-214 are then repeated as often as necessary in order to maintain a desired temperature in the passenger compartment of the electric vehicle.

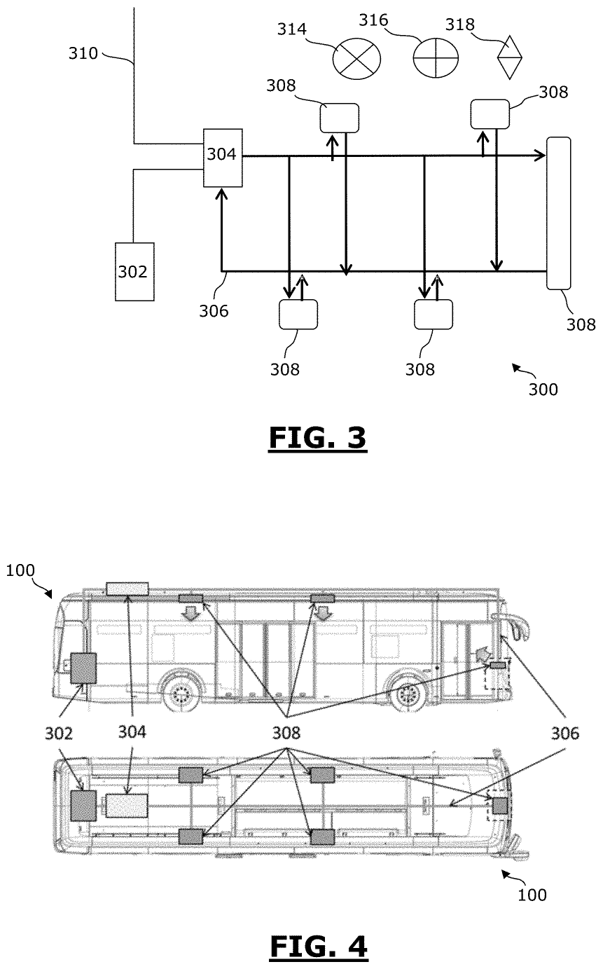

FIG. 3 is a diagrammatic representation of a non-limitative example of a system according to the invention.

The system 300 shown in FIG. 3 comprises an electrical generator 302 for generating electricity from a fossil fuel, such as for example from gasoil, petrol or biofuel.

The system 300 comprises in addition an air conditioning unit 304, comprising a condenser and a compressor, and connected to a cooling circuit 306 in which a refrigerant circulates. The system comprises in addition one or more evaporators 308, connected to the cooling circuit 306, distributed in the passenger compartment of the vehicle in order to transfer the calories from the air located in the passenger compartment of the vehicle to the refrigerant.

The system 300 comprises in addition fresh air intake means 314 in the passenger compartment, a means 316 of extracting vitiated air from the passenger compartment, as well as a thermometer 318, or equivalent, to measure and communicate the temperature.

The system comprises in addition a central module (not shown), such as an electronic board, a processor or equivalent, in order to initiate and stop the air conditioning unit 304 and the evaporators 308, in particular individually.

During the preliminary cooling step, i.e. during the pre-cooling step, the air conditioning unit 304 and the evaporators 308 are supplied by a source external to the vehicle, such as for example a charging terminal, indicated by the line 310.

During the main step, the air conditioning unit 304 and the evaporators 308 are supplied by the electrical generator 302.

FIG. 4 is a partial diagrammatic representation of the bus in FIG. 1 with the system in FIG. 3, according to a side view and a top view.

The refrigerating circuit 306 as shown in FIG. 4 runs around the main part of the vehicle 100 in the lengthwise direction, for example substantially in a central part of the roof of the vehicle 100, such that it is substantially arranged at equal distance from the side walls of the vehicle 100.

The electrical generator 302 is arranged in the rear part of the bus, for example in a rear module of the bus, and the air conditioning unit 304 is placed in the rear part of the vehicle, for example on the roof of the bus.

An evaporator 308 is placed in the driver's position at the front of the bus. The other thermal evaporators 308 are arranged in the ceiling of the passenger compartment, and more particularly in the thickness of the ceiling of the passenger compartment, throughout the vehicle, in proximity to the side walls of the bus.

Of course, the invention is not limited to the examples which have just been described.

1. A method of conditioning the air in the passenger compartment of an electric vehicle in which all of the energy for the movement thereof is supplied by an on-board electrical energy source chargeable from an external source, said method comprising:
a step, called preliminary step, carrying out a conditioning of the air in at least one part of said passenger compartment by at least one air conditioning device supplied by an electrical source external to said vehicle, when said vehicle is connected to said external electrical source, and
a step, called main step, carrying out a conditioning of the air in said at least one part of said passenger compartment by at least one air conditioning device supplied by an electrical energy source supplied by a fossil fuel tank on board said vehicle, during use of said vehicle; and
the preliminary step carries out air conditioning as a priority, in a driver's area of said vehicle.

2. The method according to claim 1, characterized in that it comprises a step of initiating the preliminary step, in particular at a distance from the vehicle.

3. A method according to claim 1, characterized in that the main step is in addition carried out from at least one battery of the vehicle, in addition to the on-board fossil fuel-based electricity source.

4. The method according to claim 1, characterized in that the preliminary step is carried out without starting the electric motor or motors of said electric vehicle.

5. The method according to claim 1, characterized in that the preliminary step is initiated automatically depending on at least one of the following parameters:
a predetermined time;
a predetermined period before said vehicle is collected, for example following an inactive/garaged phase of the vehicle;
an external temperature;
an internal temperature in at least one part of the passenger compartment,
an external humidity level; and
an internal humidity level in at least one part of the passenger compartment.

6. The method according to claim 1, characterized in that the main step is initiated automatically when:
the preliminary step is stopped,
the vehicle begins to move,
the vehicle is disconnected from the external electrical source, and/or
the temperature, respectively the humidity level, inside the at least one part of the passenger compartment which was conditioned during the preliminary step reaches a predetermined value;
immediately or optionally after a predetermined period following at least one of these events.

7. The method according to claim 1, characterized in that the preliminary step is stopped automatically when:
the main step is initiated;
the vehicle begins to move;
the vehicle is disconnected from the external electrical source; and/or
the temperature, respectively the humidity level, inside the at least one part of the passenger compartment which was conditioned during the preliminary step reaches a predetermined value;
immediately or optionally after a predetermined period following at least one of these events.

8. The method according to claim 1, characterized in that the initiation of the main step, respectively the stopping of the preliminary step, is conditional on manual confirmation by an operator or a driver of the vehicle.

9. The method according to claim 1, characterized in that the preliminary step and the main step are carried out by heat energy transfer to one and the same refrigerant.

10. The method according to claim 1, characterized in that the air conditioning carried out is a cooling or refreshing of air.

11. A system for conditioning air in the passenger compartment of an electric vehicle in which all of the energy for the movement thereof is supplied by an on-board electrical energy source which can be recharged from an external source, said system comprising:
at least one electrical air conditioning unit;
at least one electrical energy source supplied by a fossil fuel tank; and
said system configured in order to implement all the steps of the method according to claim 1.

12. The system according to claim 11, characterized in that the conditioning of the air in the passenger compartment is carried out via a refrigerant, said system comprising:
a circuit for circulating said fluid in the passenger compartment of the vehicle; and
at least one evaporator, connected to said circuit.

13. An electric vehicle comprising one of:
the system for conditioning the air according to claim 11; and
means for implementing all the steps of the method according to a method of conditioning the air in the passenger compartment of an electric vehicle in which all of the energy for the movement thereof is supplied by an on-board electrical energy source chargeable from an external source, said method comprising:
a step, called preliminary step, carrying out a conditioning of the air in at least one part of said passenger compartment by at least one air conditioning device supplied by an electrical source external to said vehicle, when said vehicle is connected to said external electrical source, and
a step, called main step, carrying out a conditioning of the air in said at least one part of said passenger compartment by at least one air conditioning device supplied by an electrical energy source supplied by a fossil fuel tank on board said vehicle, during use of said vehicle;
the preliminary step carries out air conditioning as a priority in a driver's area of said vehicle.

14. The electric vehicle according to claim 13, characterized in that it relates to an electric public transport land vehicle.

15. The electric vehicle according to claim 13, characterized in that it relates to a bus, a coach or a tired tram.
